(19) United States
(12) Patent Application Publication
(10) Pub. No.: US 2019/0200057 A1
(43) Pub. Date: Jun. 27, 2019

(54) STREAMING SYSTEM WITH A BACKUP MECHANISM AND A BACKUP METHOD THEREOF

(71) Applicant: AVerMedia Technologies, Inc., New Taipei City (TW)

(72) Inventor: Ko-Chiang Chang, New Taipei City (TW)

(21) Appl. No.: 16/232,162

(22) Filed: Dec. 26, 2018

(30) Foreign Application Priority Data
Dec. 26, 2017 (TW) 106145674

(51) Int. Cl. H04N 21/24; H04N 21/61; H04N 21/222

(52) U.S. Cl. CPC H04N 21/2404; H04N 21/222; H04N 21/6125

(57) ABSTRACT

A backup method of a streaming system includes the following steps. First, a first streaming device is configured as a master streaming device and a second streaming device is configured as an auxiliary streaming device. Second, a first communication mechanism is established between a first signal output device and the master streaming device that the data is transmitted according to the first communication mechanism. Third, a second communication mechanism is established between the first streaming device and the second streaming device that the data is transmitted according to the second communication mechanism. Fourth, a signal source heartbeat packet is transmitted from the first signal output device to the master streaming device. Fifth, an audio-visual source is transmitted from the first signal output device to the master streaming device. Sixth, the master streaming device judges whether the signal source heartbeat packet is received. Seventh, the second streaming device is configured as the master streaming device and the first streaming device is configured as the auxiliary streaming device if the signal source heartbeat packet is not received by the master streaming device.

### CROSS REFERENCE TO RELATED APPLICATIONS

This Non-provisional application claims priority under 35 U.S.C. § 119(a) on Patent Application No. 106145674 filed in Republic of China on Dec. 26, 2017, the entire contents of which are hereby incorporated by reference.

### BACKGROUND

### 1. Technical Field

The present invention relates to a streaming system and a control method thereof, in particular to a streaming system with a backup mechanism and a backup method thereof.

### 2. Description of Related Art

A streaming media means a kind of technology and a process of compressing a series of media data, transmitting the data section by section through the Internet and implementing audio and video transmission on the Internet in real time for viewing. With the adoption of the technology, a data packet may be transmitted through the Internet like the water. Without the technology, a media file must be downloaded wholly. In term of streaming transmission, a streaming device may transmit a live video through the Internet or store a film on a server in advance. During a viewer watches these audio-visual files, a specific playing software may play immediately when audio-visual data is delivered to a computer of the viewer.

However, the majority of the streaming devices run independently. When a signal source of the streaming device or the streaming device itself is trapped in an anomaly, audio-visual streaming may not be transmitted accordingly due to interruption. In this way, the viewer may have a bad experience as a result of interruption of the film.

Therefore, it is one of the important subjects to provide a streaming system with a backup mechanism and a backup method thereof.

### SUMMARY OF THE INVENTION

It is therefore an object of the present invention to provide a streaming system with a backup mechanism and a backup method thereof. Herein the streaming system may avoid interruption of audio-visual streaming under a streaming media technology due to an anomaly of a signal source or a streaming device.

To achieve the above, the present invention provides a backup method of the streaming system. The backup method includes the following steps: a first streaming device is configured as a master streaming device, and a second streaming device is configured as an auxiliary streaming device. A first communication mechanism is established between a first signal output device and the master streaming device that the data is transmitted according to the first communication mechanism. A second communication mechanism is established between the first streaming device and the second streaming device that the data is transmitted according to the second communication mechanism. The first signal output device transmits a signal source heartbeat packet to the master streaming device, and transmits an audio-visual signal source to the master streaming device. The master streaming device judges whether the signal source heartbeat packet is received. If the signal source heartbeat packet is not received, the second streaming device is configured as the master streaming device, and the first streaming device is configured as the auxiliary streaming device.

In one embodiment of the present invention, the backup method of the streaming system further includes the following step: the master streaming device transmits a backup heartbeat packet to the auxiliary streaming device. When the auxiliary streaming device judges that the backup heartbeat packet is not received, the second streaming device is configured as the master streaming device, and the first streaming device is configured as the auxiliary streaming device.

In another embodiment of the present invention, the auxiliary streaming device transmits a heartbeat packet response signal to the master streaming device upon receiving the backup heartbeat packet.

In another embodiment of the present invention, the signal source heartbeat packet is periodically transmitted to the master streaming device by the first signal output device. In addition, the signal source heartbeat packet may also be transmitted to the master streaming device by the first signal output device selectively, namely the signal source heartbeat packet may be transmitted a periodically.

In another embodiment of the present invention, the backup method of the streaming system further includes the following step: when the first signal output device fails, a second signal output device is used instead of the first signal output device. The first signal output device is judged to be disabled when the master streaming device fails to receive the audio-visual signal source.

In addition, to achieve the above, the present invention provides a streaming system with a backup mechanism. The streaming system includes a first signal output device, a first streaming device and a second streaming device. The first signal output device outputs a signal source heartbeat packet and an audio-visual signal source. Data is transmitted between the first streaming device and the first signal output device in accordance with a first communication mechanism, to receive the signal source heartbeat packet and the audio-visual signal source and output the audio-visual signal source. The data is transmitted between the second streaming device and the first streaming device in accordance with a second communication mechanism.

In another embodiment of the present invention, one of the first streaming device and the second streaming device is taken as a master streaming device, the other is taken as an auxiliary streaming device. The master streaming device receives a signal source heartbeat packet and transmits a backup heartbeat packet to the auxiliary streaming device.

In another embodiment of the present invention, the streaming system further comprises a second signal output device, which outputs the signal source heartbeat packet and an audio-visual signal source to the first streaming device or the second streaming device.

In summary, the streaming system with the backup mechanism and the backup method thereof provided by the present invention use a combination of the master streaming device and the auxiliary streaming device as core of the backup mechanism in connection with the signal source heartbeat packet and the backup heartbeat packet. When the audio-visual signal source or the streaming device is trapped in the problem, the problem may be found by the signal source heartbeat packet immediately, and the audio-visual streaming may be implemented continuously by switching to the other streaming device or the other signal output device in real time, without interruption.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram of a streaming device with a backup mechanism in a preferred embodiment of the present invention.

FIG. 2 is a flow chart of a backup method of a streaming system which is used in combination with the streaming system shown in FIG. 1.

FIG. 3 is a schematic diagram of a streaming device in another preferred embodiment of the present invention.

FIG. 4 is a schematic diagram of a streaming device with a backup mechanism in still another preferred embodiment of the present invention.

### DETAILED DESCRIPTION

Reference will now be made to the drawings to describe various inventive embodiments of the present disclosure in detail, wherein like numerals refer to like elements throughout.

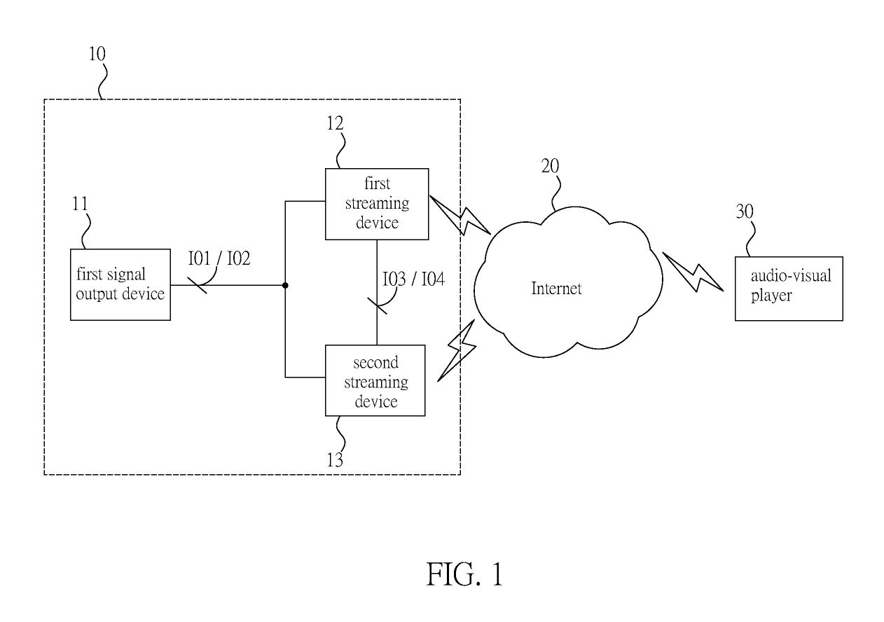

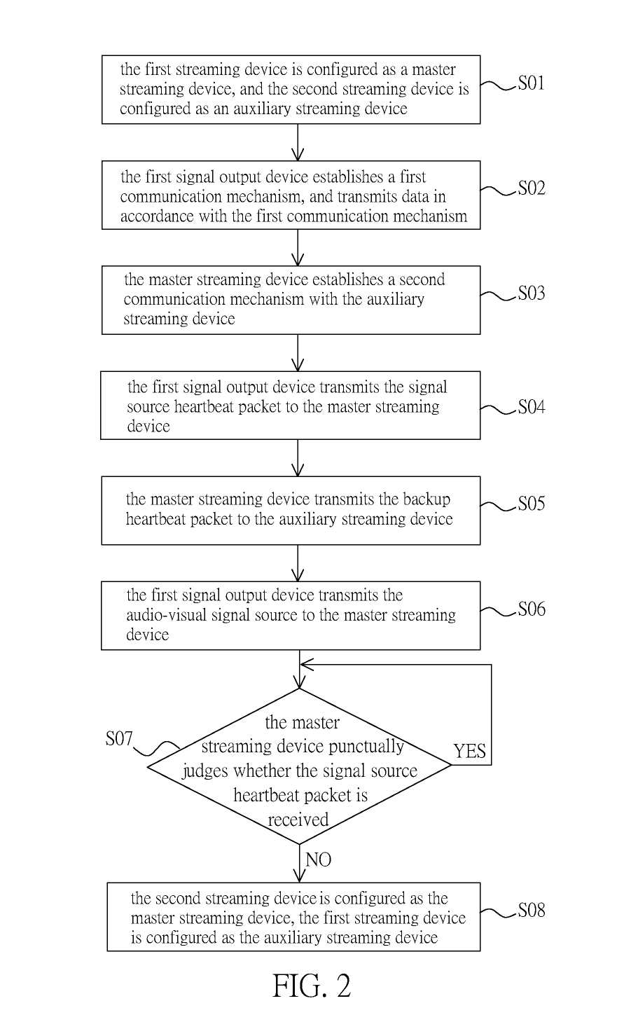

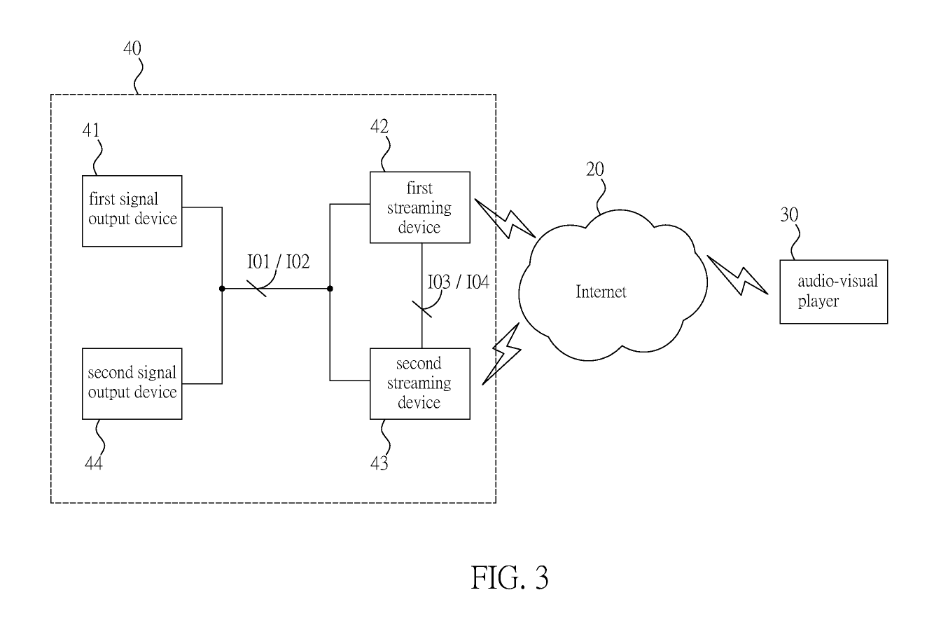

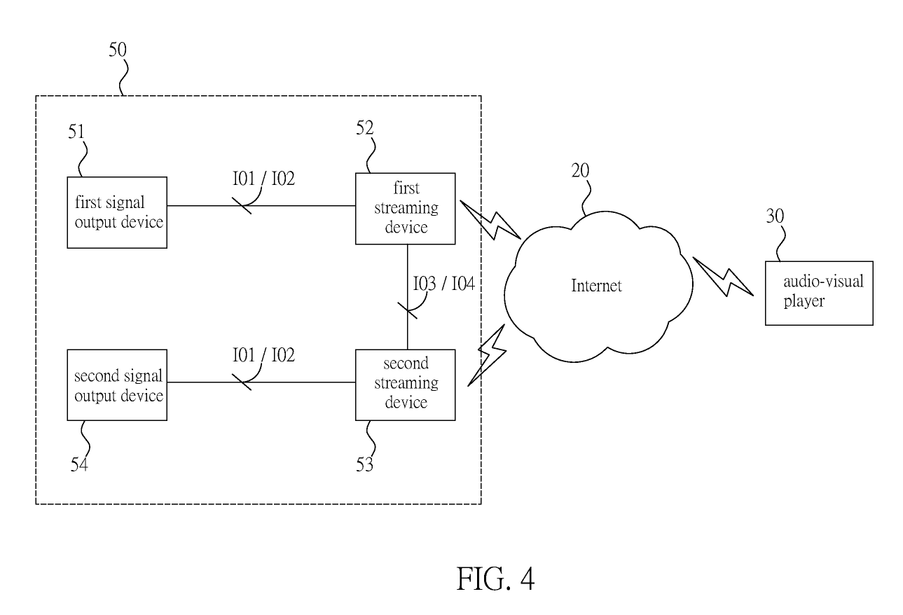

FIG. 1 is an architectural diagram of a streaming device with a backup mechanism in a preferred embodiment of the present invention. FIG. 2 is a process diagram of a backup method of a streaming system, which is used in combination with the streaming system shown in FIG. 1. FIG. 3 is an architectural diagram of a streaming device in another preferred embodiment of the present invention. FIG. 4 is an architectural diagram of a streaming device with a backup mechanism in still another preferred embodiment of the present invention.

As shown in FIG. 1, a streaming system 10 has a first signal output device 11, a first streaming device 12 and a second streaming device 13. The first signal output device 11 is electrically connected with the first streaming device 12 and the second streaming device 13 through an audio-visual signal line, for example, an HDMI transmission line or other transmission lines which are in line with a communication protocol, to transmit a high-quality audio-visual signal source I02. The first streaming device 12 and the second streaming device 13 may transmit streaming of the audio-visual signal source to an audio-visual player 30 of a viewer through the Internet 20.

The first signal output device 11 outputs a signal source heartbeat packet I01 and the audio-visual signal source I02. Herein, the signal source heartbeat packet I01 is generated and output periodically by a heartbeat packet generation unit (not shown in the figure) of the first signal output device 11, while the audio-visual signal source I02 may be broadcasted to an audio-visual file of the audio-visual player 30 of the viewer through the Internet 20. It is to be noted that the signal source heartbeat packet generally means a user-defined instruction of informing the other party of their own state between a client and a server. While in the embodiment, the signal source heartbeat packet is the instruction of informing the other party of their own state between the first signal output device 11, the first streaming device 12 and the second streaming device 13.

The first streaming device 12 is electrically connected with the first signal output device 11, and transmits data in accordance with a first communication mechanism, for example, receives the signal source heartbeat packet I01 and the audio-visual signal source I02. Herein, the signal source heartbeat packet I01 orders the first streaming device 12 to judge whether the first streaming device 12 is normally connected with the first signal output device 11 or whether the first signal output device runs normally. In addition, the first streaming device 12 may further output a backup heartbeat packet I03.

The second streaming device 13 is electrically connected with the first streaming device 12, and transmits the data in accordance with a second communication mechanism. Herein, the second streaming device 13 may receive the backup heartbeat packet I03 output by the first streaming device 12 for information synchronization upon setting of the second communication with the first streaming device 12. In addition, the second streaming device 13 may further return a heartbeat packet response signal I04 to the first streaming device 12 upon receiving the backup heartbeat packet I03.

As shown in FIG. 2, a backup method of a streaming system in a preferred embodiment of the present invention is applied to the above-mentioned streaming system 10, and the application includes the following steps.

In step S01, the first streaming device 12 is configured as a master streaming device, and the second streaming device 13 is configured as an auxiliary streaming device. Herein, the so-called auxiliary streaming device may play a backup role and be in a state of not implementing audio-visual streaming when the first signal output device 11 runs normally in combination with the master streaming device.

In step S02, the first signal output device 11 establishes a first communication mechanism, and transmits data in accordance with the first communication mechanism.

In step S03, the master streaming device establishes a second communication mechanism with the auxiliary streaming device, and transmits the data in accordance with the second communication mechanism. In the embodiment, information, such as an IP address, an account number, a password and a heartbeat packet frequency of the other party must be established for the master stream device and the auxiliary streaming device, so as to establish the second communication mechanism.

In step S04, the first signal output device 11 transmits the signal source heartbeat packet I01 to the master streaming device in accordance with the first communication mechanism. In the embodiment, the first signal output device 11 may generate and output the signal source heartbeat packet I01 periodically. Herein, a frequency, for example, is 1 Hz and not intended to be limited.

In step S05, the master streaming device transmits the backup heartbeat packet I03 to the auxiliary streaming device in accordance with the second communication mechanism. In the embodiment, the master streaming device may generate and output the backup heartbeat packet I03 periodically. Just the same as the mentioned above, the frequency, for example, is 1 Hz and not intended to be limited. Herein the backup heartbeat packet I03 may order the master streaming device to confirm whether the auxiliary streaming device runs normally and may synchronize information between the master streaming device and the auxiliary streaming device, for judgment of subsequent operation. Moreover, the auxiliary streaming device may return the heartbeat packet response signal I04 to the master streaming device upon receiving the backup heartbeat packet I03. In this way the master streaming device may master the state of the auxiliary streaming device in real time.

In step S06, the first signal output device 11 transmits the audio-visual signal source I02 to the master streaming device. The master streaming device broadcasts the audio-visual signal source I02 to the Internet 20 with a streaming media technology upon receiving the audio-visual signal source I02, while the viewer may accordingly view through an audio-visual player 30, for example, a desktop computer, a notebook computer, a mobile communication device and other electronic devices, which are connectable with the Internet.

In step S07, the master streaming device punctually judges whether the signal source heartbeat packet I01 is received. Upon receiving the signal source heartbeat packet I01 punctually, the master streaming device may continuously implement media streaming while periodically transmitting the backup heartbeat packet I03 to an auxiliary streaming host and punctually judging whether the signal source heartbeat packet I01 is received.

However, when the master streaming device fails to receive the signal source heartbeat packet I01, the step S08 may be implemented, the second streaming device 13 may be configured as the master streaming device, the first streaming device 12 may be configured as the auxiliary streaming device, and the step S02 may be implemented again. In the embodiment, the step S08 may not be implemented if the master streaming device fails to receive the signal source heartbeat packet I01 within a predetermined period. Herein the predetermined period may be different in accordance with a size of a buffering area of audio-visual streaming and adjustable masterly on the premise that the audio-visual streaming is not interrupted. In the embodiment, enough streaming buffering area needs to be reserved with a Group of Picture (GOP) technology.

In addition, in other embodiments, the above-mentioned step S07 may further include the following step: the master streaming device judges whether the audio-visual signal source I02 is received. When judging that the audio-visual signal source I02 is not received, the master streaming device judges that the first signal output device 11 fails, and may implement the step S08, so as to mastertain the normal audio-visual streaming.

Moreover, in other embodiments, the above-mentioned step S07 may further include the following step: the auxiliary streaming device may implement the step S08 when judging that the backup heartbeat packet I03 output by the master streaming device is not received within the predetermined period, so as to mastertain the normal audio-visual streaming.

In summary, the auxiliary streaming device of the present invention is taken as the backup streaming device. When the master streaming device judges that the transmission is trapped in failure by means of the signal source heartbeat packet I01 or the audio-visual signal source I02, roles of the master streaming device and the auxiliary streaming device may be exchanged in real time and accordingly audio-visual streaming may be implemented continuously. In this way, the viewer would not experience interruption of the audio-visual streaming. In addition, when the auxiliary streaming device judges that the master streaming device is trapped in an anomaly by means of the backup heartbeat packet I03, the roles of the master streaming device and the auxiliary streaming device may be exchanged in real time and accordingly audio-visual streaming may be implemented continuously. In this way, the viewer would not experience interruption of the audio-visual streaming. In short, that whether the audio-visual signal source I02, or signal source heartbeat packet I01, or the backup heartbeat packet I03 is received may be judged accordingly, namely the master streaming device and the auxiliary streaming device may be switched in real time, so as to mastertain the normal audio-visual streaming.

FIG. 3 shows a streaming system 40 with a backup mechanism in another preferred embodiment of the present invention. The streaming system includes a first signal output device 41, a first streaming device 42, a second streaming device 43 and a second signal output device 44. The first signal output device 41, the first streaming device 42 and the second streaming device 43 have a linking relationship and operating mechanisms identical with those of the first signal output device 11, the first streaming device 12 and the second streaming device 13 in the above-mentioned embodiment, and would not be repeated accordingly.

It is to be noted that the second signal output device 44 is electrically with the first streaming device 42 and the second streaming device 43 through an audio-visual signal line respectively, for example, an HDMI transmission line or other transmission lines which are in line with a communication protocol, to transmit data, namely transmit a signal source heartbeat packet I01 and a high-quality audio-visual signal source I02 in accordance with a first communication mechanism. The first streaming device 42 is electrically connected with the second streaming device 43 and transmits the data including a backup heartbeat packet I03 and a heartbeat packet response signal I04 in accordance with a second communication mechanism.

In the other embodiments, in combination with the backup method of the streaming system, that the master streaming device may not receive the audio-visual signal source I02 as result of an anomaly of the first signal output device 41 may be judged when the above-mentioned master streaming device fails to receive the audio-visual signal source I02. At this time, the first signal output device 41 may be switched to the second signal output device 44, to continuously output the audio-visual signal source I02 and accordingly prevent the audio-visual streaming from interruption.

Furthermore, as shown in FIG. 4, a streaming system 50 with a backup mechanism in still another preferred embodiment of the present invention includes a first signal output device 51, a first streaming device 52, a second streaming device 53 and a second signal output device 54.

The first signal output device 51 is electrically connected with the first streaming device 52, while the second signal output device 54 is electrically connected with the second streaming device 53. Herein, data including a signal source heartbeat packet I01 and an audio-visual signal source I02 is transmitted between the first signal output device 51 and the first streaming device 52 in accordance with a first communication mechanism, while the data including the signal source heartbeat packet I01 and the audio-visual signal source I02 is further transmitted between the second signal output device 54 and the second streaming device 53 in accordance with the first communication mechanism. The first streaming device 52 is electrically connected with the second streaming device 53 and transmits the data including a backup heartbeat packet I03 and a heartbeat packet response signal I04 in accordance with a second communication mechanism.

In the embodiment, the first signal output device 51 and the first streaming device 52 are jointly taken as a master streaming system, and the second signal output device 54 and the second streaming device 53 are jointly taken as an auxiliary streaming system. By means of the backup heartbeat packet I03 which is transmitted between the first streaming device 52 and the second streaming device 53, switching may be directly implemented between the master streaming system and the auxiliary streaming system when an anomaly of the signal source heartbeat packet I01 or the audio-visual signal source I02 is detected on the first streaming device 51 or the second streaming device 53.

From the above, the streaming system with the backup mechanism and the backup method thereof provided by the present invention use the combination of the master streaming device and the auxiliary streaming device as the core of the backup mechanism in connection with the signal source heartbeat packet and the backup heartbeat packet. When the anomaly of the signal output device or the streaming device is detected, the signal source heartbeat packet may find the problem immediately, and the audio-visual streaming may be implemented continuously by switching to the other streaming device or the other signal output device in real time, without interruption.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A backup method of streaming system, comprising:
configuring a first streaming device as a master streaming device, and configuring a second streaming device as an auxiliary streaming device;
establishing a first communication mechanism between a first signal output device and the master streaming device, and transmitting data in accordance with the first communication mechanism;
establishing a second communication mechanism between the master streaming device and the auxiliary streaming device, and transmitting the data in accordance with the second communication mechanism;
transmitting a signal source heartbeat packet to the master streaming device from the first signal output device;
transmitting an audio-visual signal source to the master streaming device from the first signal output device;
judging whether the signal source heartbeat packet is received by the master streaming device; and
configuring the second streaming device as the master streaming device, and configuring the first streaming device as the auxiliary streaming device if the signal source heartbeat packet is not received by the master streaming device.

2. The backup method of streaming system of claim 1, further comprising:
transmitting a backup heartbeat packet to the auxiliary streaming device from the master streaming device.

3. The backup method of streaming system of claim 2, wherein the auxiliary streaming device transmits a heartbeat packet response signal to the master streaming device after receiving the backup heartbeat packet.

4. The backup method of streaming system of claim 2, further comprising:
judging whether the backup heartbeat packet is received by the auxiliary streaming device; and
configuring the second streaming device as the master streaming device, and configuring the first streaming device as the auxiliary streaming device if the auxiliary streaming device judges that the backup heartbeat packet is not received.

5. The backup method of streaming system of claim 1, wherein the signal source heartbeat packet is periodically transmitted to the master streaming device by the first signal output device.

6. The backup method of streaming system of claim 1, further comprising:
replacing the first signal output device by a second signal output device when the first signal output device is disabled.

7. The backup method of streaming system of claim 6, wherein the first signal output device is judged to be disabled when the master streaming device fails to receive the audio-visual signal source.

8. A streaming system with backup mechanism, comprising:
a first signal output device, which outputs a signal source heartbeat packet and an audio-visual signal source;
a first streaming device, which is to transmit data between the first signal output device in accordance with a first communication mechanism, to receive the signal source heartbeat packet and the audio-visual signal source and to output the audio-visual signal source; and
a second streaming device, which is to transmit data between the first streaming device in accordance with a second communication mechanism.

9. The streaming system with backup mechanism of claim 8, further comprising:
a second signal output device, which outputs the signal source heartbeat packet or an audio-visual signal source.

10. The streaming system with backup mechanism of claim 9, wherein the signal source heartbeat packet or an audio-visual signal source is transmitted to the first streaming device or the second streaming device.

11. The streaming system with backup mechanism of claim 8, wherein the first streaming device further outputs a backup heartbeat packet to the second streaming device.
